(19) United States
(12) Patent Application Publication
(10) Pub. No.: US 2024/0399662 A1
(43) Pub. Date: Dec. 5, 2024

(54) Method Of Manufacturing Three-Dimensional Shaped Object

(71) Applicant: SEIKO EPSON CORPORATION, Tokyo (JP)

(72) Inventors: Akihiko TSUNOYA, Okaya (JP); Takayuki YOKOYAMA, Matsumoto (JP)

(21) Appl. No.: 18/676,617

(22) Filed: May 29, 2024

(30) Foreign Application Priority Data
May 30, 2023 (JP) 2023-088770

(51) Int. Cl. B29C 64/25; B29C 64/386; B33Y 10/00; B33Y 50/00

(52) U.S. Cl. CPC B29C 64/25; B29C 64/386; B33Y 10/00; B33Y 50/00

(57) ABSTRACT

A method of manufacturing a three-dimensional shaped object includes a shaping step of controlling a discharge unit of the three-dimensional shaping apparatus based on shaping data in a state in which a shaping door provided in a housing of the three-dimensional shaping apparatus is locked and shaping the three-dimensional shaped object in the housing and an unlock control step of, after the shaping step, controlling unlocking of the shaping door based on the shaping data, first identification information for identifying a user who transmitted the shaping data, and second identification information for identifying the three-dimensional shaping apparatus.

The present application is based on, and claims priority from JP Application Serial Number 2023-088770, filed May 30, 2023, the disclosure of which is hereby incorporated by reference herein in its entirety.

### BACKGROUND

### 1. Technical Field

The present disclosure relates to a method of manufacturing a three-dimensional shaped object.

### 2. Related Art

For example, JP-A-2017-177576 discloses a system that requests user authentication information at the time of shaping of a three-dimensional shaped object and, when the user authentication information matches user authentication information relating to shaping data of the shaped object, permits the shaping of the shaped object.

JP-A-2017-177576 is an example of the related art.

The technique disclosed in JP-A-2017-177576 is a technique for preventing a user having no relation to shaping data from shaping a three-dimensional shaped object using the shaping data. Handling of the shaped three-dimensional shaped object is not examined in the technique. For example, when a plurality of users use one three-dimensional shaping apparatus, it is likely that a shaped three-dimensional shaped object is taken out by a user different from a user who has transmitted shaping data of the three-dimensional shaped object. Therefore, there has been a demand for a technique that can prevent a user other than a user who has transmitted shaping data from taking out a three-dimensional shaped object.

### SUMMARY

According to a first aspect of the present disclosure, a method of manufacturing a three-dimensional shaped object is provided. The method of manufacturing a three-dimensional shaped object includes: a shaping step of, in a state in which a shaping door provided in a housing of a three-dimensional shaping apparatus is locked, controlling a discharge unit of the three-dimensional shaping apparatus based on shaping data and shaping the three-dimensional shaped object in the housing; and an unlock control step of, after the shaping step, controlling unlocking of the shaping door based on the shaping data, first identification information for identifying a user who transmitted the shaping data, and second identification information for identifying the three-dimensional shaping apparatus.

### BRIEF DESCRIPTION OF THE DRAWINGS

FIG. 1 is an explanatory drawing illustrating a schematic configuration of a three-dimensional shaping system.

FIG. 2 is an explanatory drawing illustrating a schematic configuration of a three-dimensional shaping apparatus.

FIG. 3 is a perspective view illustrating a schematic configuration of a screw.

FIG. 4 is a schematic plan view of a barrel.

FIG. 5 is an explanatory drawing schematically illustrating a state in which the three-dimensional shaping apparatus shapes a shaped object.

FIG. 6 is a process chart of three-dimensional shaped object manufacturing processing executed by the three-dimensional shaping system.

FIG. 7 is a diagram illustrating a sequence of an upload step.

FIG. 8 is a diagram illustrating a login screen.

FIG. 9 is a diagram illustrating a menu screen.

FIG. 10 is a diagram illustrating an upload screen.

FIG. 11 is a diagram illustrating a sequence of a shaping preparation step.

FIG. 12 is a diagram illustrating a shaping menu screen.

FIG. 13 is a diagram illustrating a preview screen.

FIG. 14 is a diagram illustrating a sequence of a shaping step.

FIG. 15 is a diagram illustrating a sequence of an unlock control step.

FIG. 16 is a diagram illustrating a sequence of a shaping step in a second embodiment.

FIG. 17 is a diagram illustrating a sequence of an unlock control step in the second embodiment.

FIG. 18 is a diagram illustrating a sequence of an unlock control step in a third embodiment.

FIG. 19 is a diagram illustrating a sequence of an unlock control step in a fourth embodiment.

### DESCRIPTION OF EMBODIMENTS

### A. First Embodiment

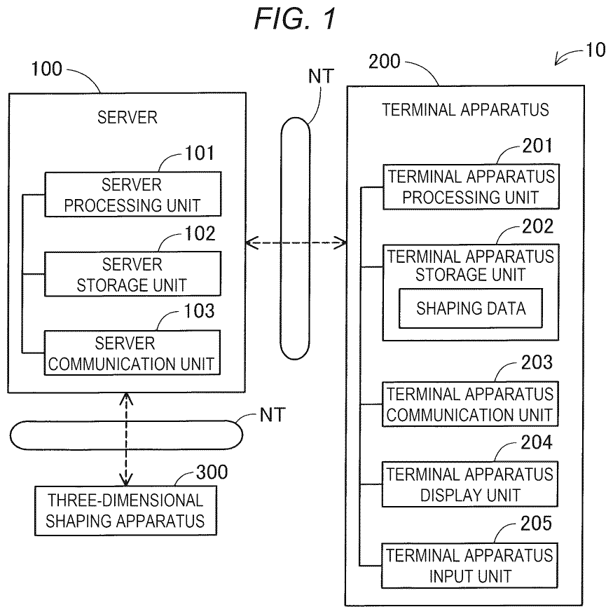

FIG. 1 is an explanatory drawing illustrating a schematic configuration of a three-dimensional shaping system 10. The three-dimensional shaping system 10 includes a server 100, a terminal apparatus 200, and a three-dimensional shaping apparatus 300. The server 100 is configured to be capable of mutually communicating with the terminal apparatus 200 and the three-dimensional shaping apparatus 300 via a network NT. The network NT may be a LAN, may be a WAN, or may be the Internet. FIG. 1 illustrates an example in which the three-dimensional shaping system 10 includes one terminal apparatus 200 and one three-dimensional shaping apparatus 300. However, the three-dimensional shaping system 10 may include a plurality of terminal apparatuses 200 or a plurality of three-dimensional shaping apparatuses 300.

The server 100 manages information concerning a three-dimensional shaped object shaped by the three-dimensional shaping apparatus 300. The server 100 is configured with a computer including a server processing unit 101, a server storage unit 102, and a server communication unit 103. The server processing unit 101 includes one or a plurality of processors. The server processing unit 101 executes a program stored in the server storage unit 102 to control the operation of the server 100. The server storage unit 102 includes a main storage device such as a RAM and an auxiliary storage device such as a hard disk drive. The server communication unit 103 includes a communication circuit for controlling communication with other apparatuses such as the terminal apparatus 200 and the three-dimensional shaping apparatus 300. The server 100 may be configured with a plurality of computers. At least a part of the functions of the server 100 may be implemented as a cloud server.

The terminal apparatus 200 is configured as a computer including a terminal apparatus processing unit 201, a terminal apparatus storage unit 202, a terminal apparatus communication unit 203, a terminal apparatus display unit 204, and a terminal apparatus input unit 205. The terminal apparatus 200 is, for example, a smartphone, a tablet terminal, or a handy terminal. The terminal apparatus processing unit 201 includes one or a plurality of processors. The terminal apparatus processing unit 201 executes a program stored in the terminal apparatus storage unit 202 to control the operation of the terminal apparatus 200. The terminal apparatus storage unit 202 includes a volatile memory such as a RAM and a nonvolatile memory such as a flash memory. The terminal apparatus communication unit 203 controls communication with other apparatuses such as the server 100. Various screens are displayed on the terminal apparatus display unit 204. The terminal apparatus input unit 205 receives input from a user. In the present embodiment, the terminal apparatus display unit 204 and the terminal apparatus input unit 205 are integrated as a touch panel. Note that the terminal apparatus display unit 204 and the terminal apparatus input unit 205 may be configured separately. For example, the terminal apparatus display unit 204 may be configured from a liquid crystal display. The terminal apparatus input unit 205 may be configured from buttons and a keyboard.

The terminal apparatus storage unit 202 stores shaping data of a three-dimensional shaped object. The shaping data is, for example, shape data representing the shape of a three-dimensional shaped object created using three-dimensional CAD software, three-dimensional CG software, or the like or slice data representing the shape of a three-dimensional shaped object sliced into a plurality of layers along the horizontal plane.

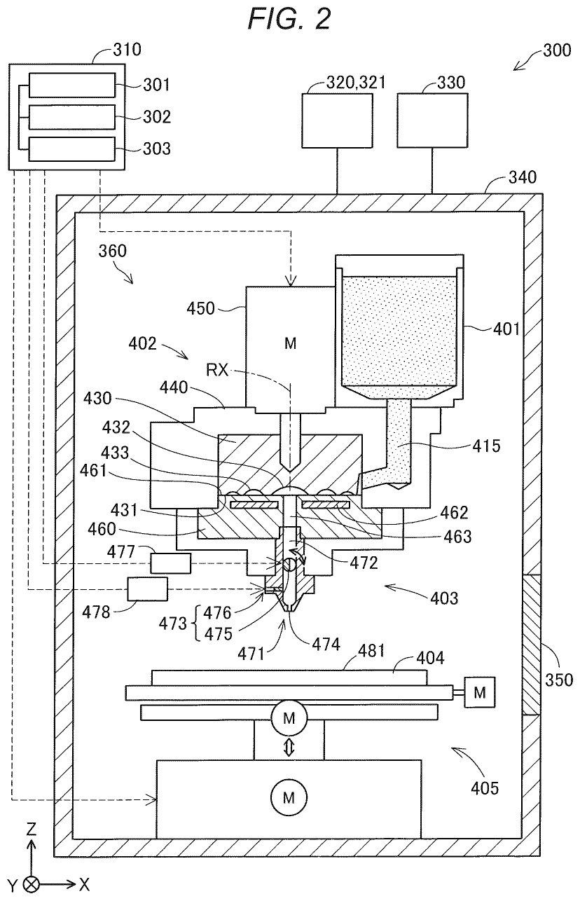

FIG. 2 is an explanatory drawing illustrating a schematic configuration of the three-dimensional shaping apparatus 300. In FIG. 2, arrows indicating X, Y, and Z directions orthogonal to each other are illustrated. The X direction and the Y direction are parallel to the horizontal plane. The Z direction is a direction parallel to the vertical direction. The X, Y, and Z directions in FIG. 2 and the X, Y, and Z directions in the other figures indicate the same directions. When a direction is specified, a positive direction indicated by an arrow is referred to as “+”, and a negative direction opposite to the direction indicated by the arrow is referred to as “−” to use the plus and minus signs for direction notation.

The three-dimensional shaping apparatus 300 is an apparatus that shapes a shaped object with a material extrusion method. The three-dimensional shaping apparatus 300 includes a control unit 310, a shaping apparatus display unit 320, a shaping apparatus input unit 321, a reading unit 330, a housing 340, a shaping door 350, and a shaping unit 360.

The control unit 310 is configured with a computer including a shaping apparatus processing unit 301, a shaping apparatus storage unit 302, and a shaping apparatus communication unit 303. The shaping apparatus processing unit 301 includes one or a plurality of processors. The shaping apparatus processing unit 301 executes a program stored in the shaping apparatus storage unit 302 to control the operation of the three-dimensional shaping apparatus 300. The shaping apparatus storage unit 302 is configured with a storage device such as a memory. The shaping apparatus communication unit 303 includes a communication circuit for controlling communication with other apparatuses such as the server 100. Note that, instead of being configured with a computer, the control unit 310 may be implemented by a configuration in which a plurality of circuits for realizing at least a part of functions are combined.

The shaping apparatus display unit 320 displays a screen output by the shaping apparatus processing unit 301. The shaping apparatus input unit 321 receives input from a user. In the present embodiment, the shaping apparatus display unit 320 and the shaping apparatus input unit 321 are integrated as a touch panel. Note that the shaping apparatus display unit 320 and the shaping apparatus input unit 321 may be configured separately. For example, the shaping apparatus display unit 320 may be configured with a liquid crystal display. The shaping apparatus input unit 321 may be configured with buttons or the like.

The reading unit 330 reads a code such as a two-dimensional code or a barcode and acquires information included in the read code.

The shaping door 350 is provided on a side surface of the housing 340 to be able to be locked and unlocked.

Under the control of the control unit 310, the shaping unit 360 discharges, onto a stage 404, a shaping material formed by plasticizing a solid-state material into a paste state to shape a three-dimensional shaped object. The shaping unit 360 is provided on the inside of the housing 340. In other words, the three-dimensional shaped object is shaped in the housing 340. The shaping unit 360 includes a material supply unit 401, a plasticizing unit 402, a discharge unit 403, the stage 404, and a moving mechanism 405.

The material supply unit 401 supplies a material for generating the shaping material to the plasticizing unit 402. The material supply unit 401 is configured with, for example, a hopper. The material supply unit 401 stores a pellet-shaped or powdery material. As the material, thermoplastic resin such as polypropylene resin (PP), polyethylene resin (PE), or polyacetal resin (POM) is used. The material supply unit 401 supplies the material to the plasticizing unit 402 via a communication path 415.

The plasticizing unit 402 plasticizes at least a part of the material supplied from the material supply unit 401, generates a paste-like shaping material having flowability, and guides the shaped material to the discharge unit 403. Here, “plasticizing” is a concept including melting and means changing a solid state to a state having flowability. Specifically, in the case of a material in which glass transition occurs, plasticizing means raising the temperature of the material to the glass transition point or higher. In the case of a material in which glass transition does not occur, plasticizing means raising the temperature of the material to the melting point or higher. The plasticizing unit 402 includes a screw 430, a screw case 440, a drive motor 450, and a barrel 460.

The screw 430 is housed in the screw case 440. The upper surface side of the screw 430 is coupled to the drive motor 450. The screw 430 is rotated in the screw case 440 by a rotational driving force generated by the drive motor 450. The axial direction of a rotation axis RX of the screw 430 is a direction in the Z direction. The rotating speed of the screw 430 is controlled by the control unit 310 controlling the rotating speed of the drive motor 450. Note that the screw 430 may be driven by the drive motor 450 via a decelerator. The screw 430 is also called a rotor or a flat screw.

The barrel 460 is installed on the-Z direction side of the screw 430. A facing surface 461, which is the upper surface of the barrel 460, faces a lower surface 431 of the screw 430. A communication hole 463 communicating with a flow path 472 of the discharge unit 403 is formed at the center of the barrel 460. A plasticizing heater 462 is provided on the inside of the barrel 460. The temperature of the plasticizing heater 462 is controlled by the control unit 310.

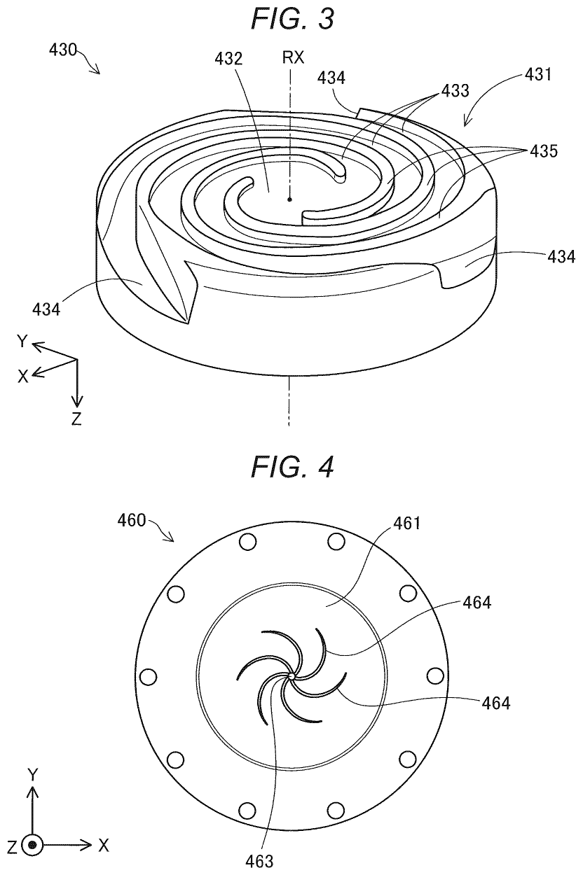

FIG. 3 is a perspective view illustrating a schematic configuration of the screw 430. The screw 430 has a substantially cylindrical shape in which the length in a direction along the rotation axis RX is smaller than the length in a direction perpendicular to the rotation axis RX. On the lower surface 431 of the screw 430, spiral grooves 433 is formed centering on a center 432. The grooves 433 communicate with a material charging port 434 formed in a side surface of the screw 430. The material supplied from the material supply unit 401 is supplied to the grooves 433 through the material charging port 434. The groove 433 is formed by being separated by convex ridge portions 435. Although FIG. 3 illustrates an example in which three grooves 433 are formed, the number of grooves 433 may be one or may be two or more. The shape of the groove 433 is not limited to the spiral shape and may be a helical shape or an involute curve shape or may be a shape extending to draw an arc from the center 432 toward the outer circumference.

FIG. 4 is a schematic plan view of the barrel 460. A plurality of guide grooves 464 are formed around the communication hole 463 on the facing surface 461. One end of each of the guide grooves 464 is coupled to the communication hole 463. The guide groove 464 spirally extends from the communication hole 463 toward the outer circumference of the facing surface 461. Note that one end of the guide groove 464 may not be coupled to the communication hole 463. Further, the guide grooves 464 may not be formed in the barrel 460.

The material supplied to the grooves 433 of the screw 430 flows along the grooves 433 while being plasticized in the grooves 433 by the rotation of the screw 430 and the heating of the plasticizing heater 462 and is guided to the center 432 of the screw 430 as a shaping material. The paste-like shaping material exhibiting flowability flowed into the center 432 is supplied to the discharge unit 403 via the communication hole 463. Note that, in the plasticizing unit 402, not all kinds of substances forming the shaping material may be plasticized. The shaping material only has to be converted into a state having flowability as a whole by at least a part of the substances forming the shaping material being plasticized.

The discharge unit 403 discharges the shaping material. The discharge unit 403 includes a nozzle 471, the flow path 472, and a discharge control unit 473.

The nozzle 471 is coupled to the communication hole 463 of the barrel 460 through the flow path 472. The nozzle 471 discharges the shaping material generated in the plasticizing unit 402 from a nozzle opening 474 at the tip of the nozzle 471 toward the stage 404.

The discharge control unit 473 includes a discharge adjustment unit 475 that opens and closes the flow path 472 and a suction unit 476 that sucks and temporarily pools the shaping material.

The discharge adjustment unit 475 is provided in the flow path 472 and changes an opening degree of the flow path 472 by rotating in the flow path 472. In the present embodiment, the discharge adjustment unit 475 is configured with a butterfly valve. The discharge adjustment unit 475 is driven by a first drive unit 477 under the control of the control unit 310. The first drive unit 477 is configured with, for example, a stepping motor. The control unit 310 can adjust a flow rate of the shaping material flowing from the plasticizing unit 402 to the nozzle 471, that is, a discharge amount of the shaping material discharged from the nozzle 471 by controlling a rotation angle of the butterfly valve using the first drive unit 477. The discharge adjustment unit 475 is capable of adjusting the discharge amount of the shaping material and capable of controlling ON/OFF of the outflow of the shaping material.

The suction unit 476 is coupled between the discharge adjustment unit 475 and the nozzle opening 474 in the flow path 472. The suction unit 476 temporarily sucks the shaping material in the flow path 472 at the time of a stop of the discharge of the shaping material from the nozzle 471 to thereby suppress a tailing phenomenon in which the shaping material hangs from the nozzle opening 474 like a string. In the present embodiment, the suction unit 476 is configured with a plunger. The suction unit 476 is driven by a second drive unit 478 under the control of the control unit 310. The second drive unit 478 is configured with, for example, a stepping motor and a rack-and-pinion mechanism that converts a rotational force of the stepping motor into a translational motion of a plunger.

The stage 404 is disposed at a position facing the nozzle opening 474 of the nozzle 471. The three-dimensional shaping apparatus 300 shapes a three-dimensional shaped object by ejecting the shaping material from the nozzle 471 onto a shaping surface 481, which is the upper surface of the stage 404, to stack shaping layers.

The moving mechanism 405 changes relative positions of the nozzle 471 and the stage 404. In the present embodiment, the moving mechanism 405 moves the stage 404 with respect to the nozzle 471 whose position is fixed. The change in the relative position of the nozzle 471 with respect to the stage 404 is simply referred to as movement of the nozzle 471 as well. The moving mechanism 405 is configured with a three-axis positioner that moves the stage 404 in three axial directions of the X, Y, and Z directions with driving forces of three motors. The motors of the moving mechanism 405 are driven under the control of the control unit 310. Note that the moving mechanism 405 may be configured to move the nozzle 471 in a state in which the position of the stage 404 is fixed rather than being configured to move the stage 404. The moving mechanism 405 may be configured to move both of the stage 404 and the nozzle 471.

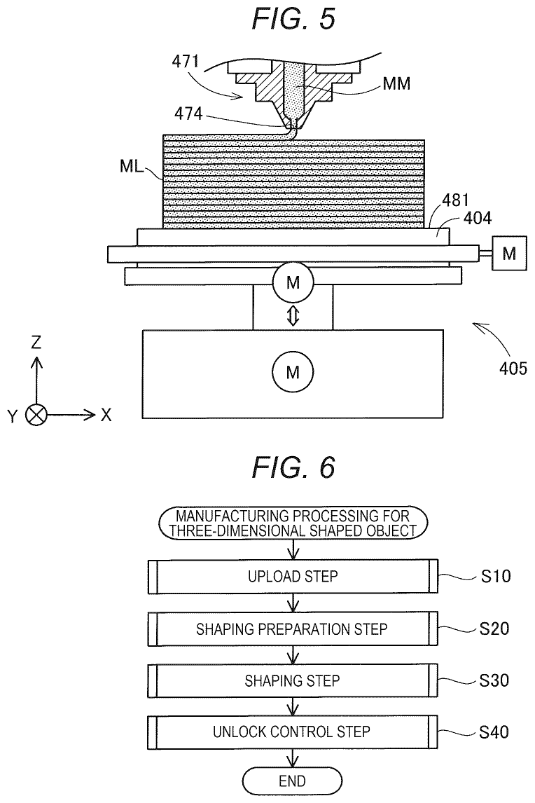

FIG. 5 is an explanatory drawing schematically illustrating a state in which the three-dimensional shaping apparatus 300 shapes a shaped object. In the three-dimensional shaping apparatus 300, as explained above, the material in the solid state is plasticized to generate a shaping material MM. The control unit 310 discharges the shaping material MM from the nozzle 471 while changing the position of the nozzle 471 with respect to the stage 404 in the direction extending along the shaping surface 481 of the stage 404 with the distance between the shaping surface 481 of the stage 404 and the nozzle 471 kept. The shaping material MM discharged from the nozzle 471 is continuously deposited in a moving direction of the nozzle 471.

The control unit 310 repeats the movement of the nozzle 471 to form a layer ML. After forming one layer ML, the control unit 310 relatively moves the position of the nozzle 471 with respect to the stage 404 in the Z direction. Then, the control unit 310 shapes a shaped object by further stacking the layer ML on the layer ML that has been formed to that point.

For example, the control unit 310 sometimes temporarily interrupts the movement of the nozzle 471 in the Z direction in the case in which the formation of the layer ML for one layer is completed or the discharge of the shaping material MM from the nozzle 471 in the case in which there are a plurality of independent shaping regions in the layers ML. In this case, the control unit 310 closes the flow path 472 with the discharge adjustment unit 475, stops the discharge of the shaping material MM from the nozzle opening 474, and temporarily sucks the shaping material MM in the nozzle 471 with the suction unit 476. After changing the position of the nozzle 471, the control unit 310 opens the flow path 472 with the discharge adjustment unit 475 while discharging the shaping material MM in the suction unit 476 to thereby restart the deposit of the shaping material MM from the changed position of the nozzle 471.

FIG. 6 is a process chart of three-dimensional shaped object manufacturing processing executed by the three-dimensional shaping system 10. The three-dimensional shaped object manufacturing processing is executed when predetermined operation is performed on the three-dimensional shaping system 10. First, in step S10, an upload step is executed. Subsequently, in step S20, a shaping preparation step is executed. Subsequently, in step S30, a shaping step is executed. Finally, in step S40, an unlock control step is executed.

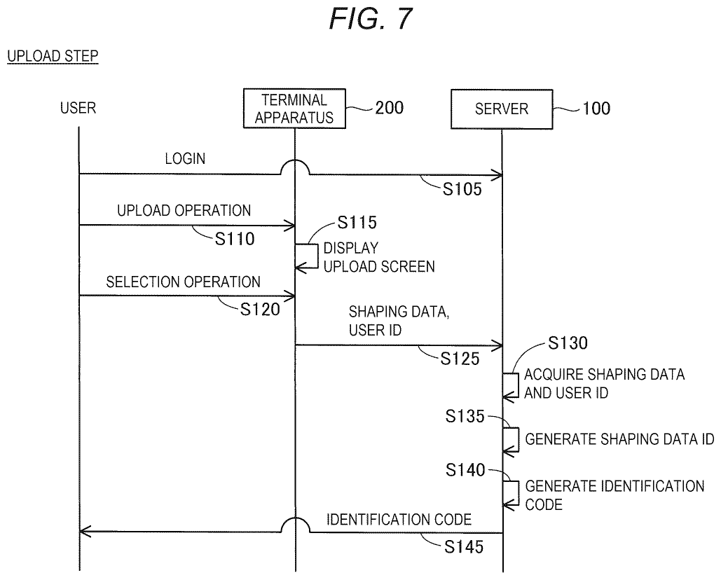

FIG. 7 is a diagram illustrating a sequence of the upload step.

In step S105, a user logs in to the server 100. The user accesses the server 100, for example, by starting a web browser in the terminal apparatus 200 and inputting a URL. When receiving a connection request from the terminal apparatus 200, the server 100 transmits a login screen SC1 to the terminal apparatus 200. The login screen SC1 is displayed on the terminal apparatus display unit 204.

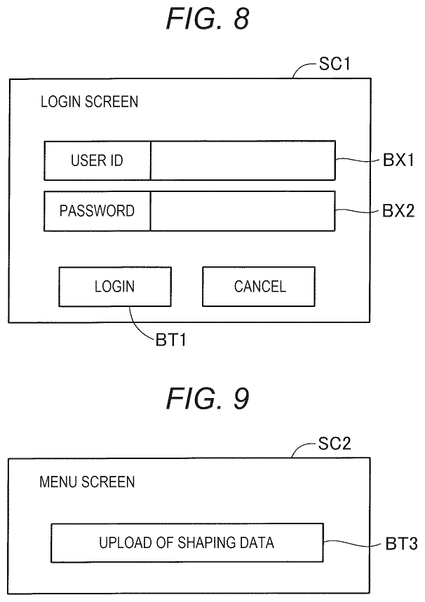

FIG. 8 is a diagram illustrating the login screen SC1. On the login screen SC1, a user ID input field BX1, a password input field BX2, and a login button BT1 are provided. The user inputs a user ID and a password respectively to the user ID input field BX1 and the password input field BX2 and taps the login button BT1. Here, the user ID is identification information allocated to each user. The user ID is referred to as first identification information as well. The terminal apparatus 200 transmits the user ID and the password input to the login screen SC1 to the server 100. When the received user ID and the received password match a user ID and a password registered in advance, the server 100 authenticates the user's login. When the received user ID and the received password do not match the user ID and the password registered in advance, the server 100 does not authenticate the user's login. When the user's login is authenticated, a menu screen SC2 is displayed on the terminal apparatus display unit 204. In the following explanation, it is assumed that the user's login to the server 100 has been authenticated in step S105 in FIG. 7.

FIG. 9 is a diagram illustrating the menu screen SC2. On the menu screen SC2, an “upload of shaping data” button BT3 is provided.

In step S110 of FIG. 7, the user executes upload operation on the terminal apparatus 200. Specifically, the user taps the “upload of shaping data” button BT3 on the menu screen SC2.

In step S115, the terminal apparatus 200 causes the terminal apparatus display unit 204 to display an upload screen SC3.

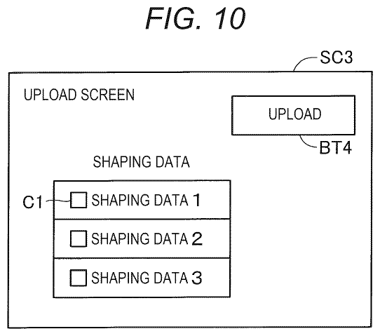

FIG. 10 is a diagram illustrating the upload screen SC3. The upload screen SC3 is a screen on which the user selects shaping data to be uploaded to the server 100. On the upload screen SC3, shaping data stored in the terminal apparatus storage unit 202 is displayed. On the upload screen SC3, check boxes Cl associated with the shaping data and an upload button BT4 are provided.

In step S120 in FIG. 7, the user executes selection operation on the terminal apparatus 200. The user selects the check box Cl corresponding to shaping data to be uploaded to the server 100 from the shaping data displayed on the upload screen SC3 and taps the upload button BT4. When the selection operation is executed, steps S125 to S145 are executed.

In step S125, the terminal apparatus 200 transmits the shaping data selected in step S120 and the user ID used for the login in step S105 to the server 100.

In step S130, the server 100 acquires the shaping data and the user ID transmitted in step S125. Step S130 is referred to as first step as well.

In step S135, the server 100 generates a shaping data ID in which the shaping data and the user ID acquired in step S130 are correlated. The shaping data ID is identification information allocated to a set of one piece of shaping data and one user ID. The shaping data ID is referred to as third identification information as well. The server 100 stores the shaping data ID, the shaping data relating to the shaping data ID, and the user ID relating to the shaping data ID in the server storage unit 102 in correlation with one another. Step S135 is referred to as second step as well.

In step S140, the server 100 generates an identification code of the shaping data ID, which is information for identifying the shaping data ID. The identification code of the shaping data ID is a two-dimensional code, a barcode, or the like. The identification code of the shaping data ID includes the shaping data ID as information. The identification code of the shaping data ID is referred to as fourth identification information as well. In the following explanation, the identification code of the shaping data ID is simply referred to as identification code as well.

In step S145, the server 100 transmits the identification code generated in step S140 to a user relating to the identification code. Here, the user relating to the identification code is a user having a user ID relating to the shaping data ID included in the identification code as the information. In the present embodiment, the server 100 transmits the identification code to the terminal apparatus 200 used by the user relating to the identification code to log in to the server 100. The server 100 may transmit the identification code to the terminal apparatus 200 by mail or may transmit the identification code to the terminal apparatus 200 using an application installed in advance in the terminal apparatus 200. Note that the server 100 may cause the storage unit 102 to store the identification code such that the user relating to the identification code is capable of accessing the identification code in a state in which the user logs in to the server 100. Steps S140 and S145 are also collectively referred to as third step as well. As explained above, the upload step is executed.

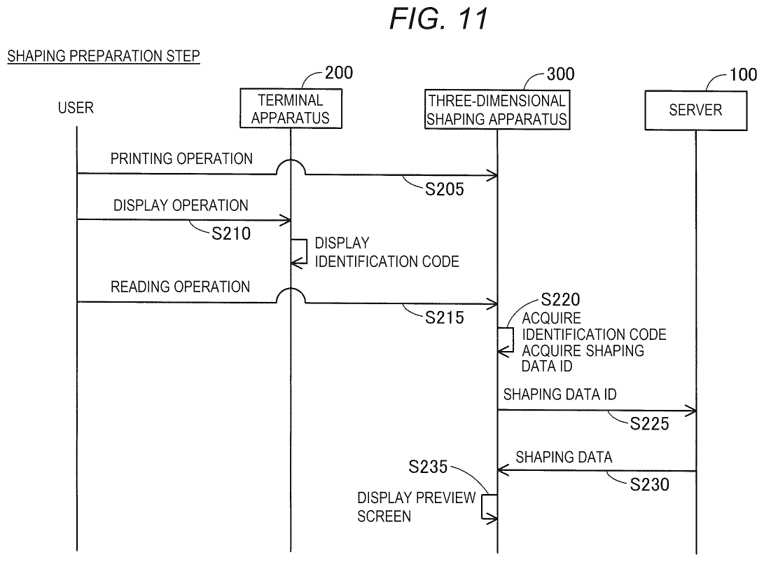

FIG. 11 is a diagram illustrating a sequence of the shaping preparation step. First, in step S205, the user executes printing operation on the three-dimensional shaping apparatus 300.

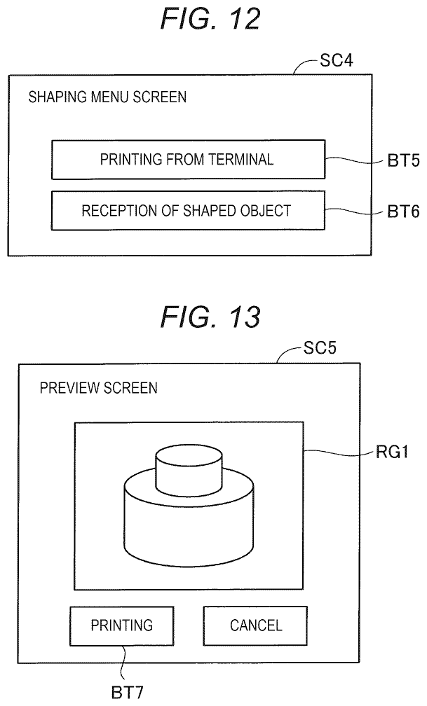

FIG. 12 is a diagram illustrating a shaping menu screen SC4 displayed on the shaping apparatus display unit 320. The shaping menu screen SC4 includes a “print from terminal” button BT5 and a “receive shaped object” button BT6. In step S205, the user taps the “print from terminal” button BT5 on the shaping menu screen SC4. When the “print from terminal” button BT5 is tapped, the three-dimensional shaping apparatus 300 causes the shaping apparatus display unit 320 to display a pop-up window on which a message “Please let me read a two-dimensional code.” is displayed.

In step S210, the user executes display operation on the terminal apparatus 200. The user causes the terminal apparatus display unit 204 to display an identification code of a three-dimensional shaped object for which the user causes the three-dimensional shaping apparatus 300 to execute shaping.

In step S215, the user executes reading operation on the three-dimensional shaping apparatus 300. The user causes the reading unit 330 of the three-dimensional shaping apparatus 300 to read the identification code displayed on the terminal apparatus display unit 204. When the reading operation is executed, steps S220 to S235 are executed.

In step S220, the three-dimensional shaping apparatus 300 acquires the identification code read by the reading unit 330. The three-dimensional shaping apparatus 300 acquires, from the acquired identification code, the shaping data ID included in the identification code as the information. Step S220 is referred to as fourth step as well.

In step S225, the three-dimensional shaping apparatus 300 transmits the shaping data ID acquired in step S220 to the server 100. Step S225 is referred to as fifth step as well.

In step S230, the server 100 transmits the shaping data stored in the server storage unit 102 in correlation with the shaping data ID transmitted in step S225 to the three-dimensional shaping apparatus 300 to which the shaping data ID has been transmitted in step S225. Step S230 is referred to as sixth step as well.

In step S235, the three-dimensional shaping apparatus 300 acquires the shaping data transmitted in step S230 and causes the shaping apparatus display unit 320 to display a preview screen SC5.

FIG. 13 is a diagram illustrating the preview screen SC5. On the preview screen SC5, a preview region RG1 and a print button BT7 are provided. In the preview region RG1, the exterior of a three-dimensional shaped object shaped using the shaping data acquired in step S235 is displayed. The shaping data ID transmitted in step S225 may be displayed on the preview screen SC5. On the preview screen SC5, the preview region RG1 may not be provided. As explained above, the shaping preparation step is executed.

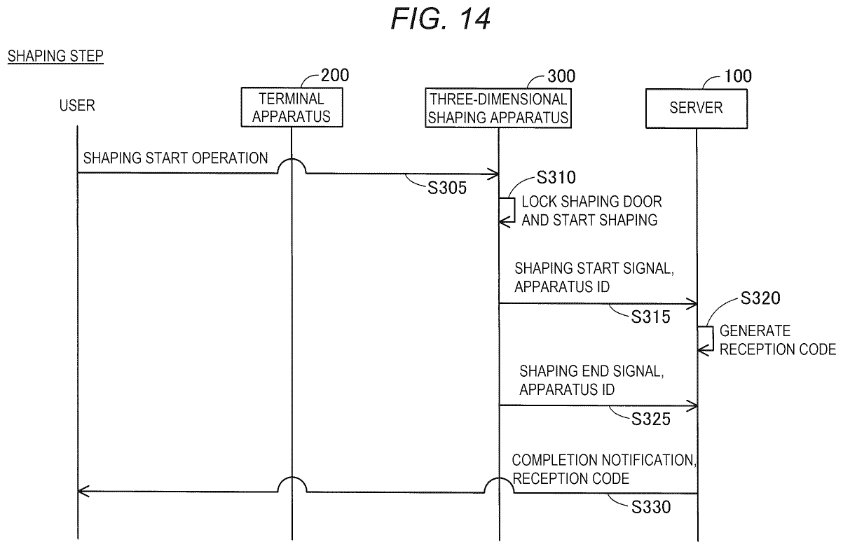

FIG. 14 is a diagram illustrating a sequence of the shaping step.

In step S305, the user executes shaping start operation on the three-dimensional shaping apparatus 300. The user taps the print button BT7 on the preview screen SC5 illustrated in FIG. 13. When the shaping start operation is executed, steps S310 to S330 are executed.

In step S310, the three-dimensional shaping apparatus 300 locks the shaping door 350 and starts shaping of a three-dimensional shaped object. The three-dimensional shaping apparatus 300 controls the discharge unit 403 based on the shaping data acquired in step S235 of the shaping preparation step to shape a three-dimensional shaped object in the housing 340.

In step S315, the three-dimensional shaping apparatus 300 transmits, to the server 100, a shaping start signal for notifying that the shaping of the three-dimensional shaped object has been started and an apparatus ID of the three-dimensional shaping apparatus 300. The apparatus ID is identification information allocated to each three-dimensional shaping apparatus 300. The apparatus ID is referred to as second identification information as well. The apparatus ID transmitted to the server 100 in step S315 is the apparatus ID of the three-dimensional shaping apparatus 300 that has started the shaping of the three-dimensional shaped object.

In step S320, the server 100 acquires the shaping start signal and the apparatus ID transmitted in step S315 and generates a shaped object reception code in which the acquired apparatus ID and a shaping data ID relating to the three-dimensional shaped object for which the shaping has been started are correlated. Here, the shaping data ID relating to the three-dimensional shaped object for which the shaping has been started is a shaping data ID relating to shaping data of the three-dimensional shaped object for which the shaping has been started. Specifically, the shaping data is the shaping data ID transmitted in step S225 of the shaping preparation step. The shaped object reception code is a two-dimensional code, a barcode, or the like. The shaped object reception code includes the apparatus ID and the shaping data ID as information. The shaped object reception code is referred to as fifth identification information as well. In the following explanation, the shaped object reception code is simply referred to as reception code as well. The server 100 stores the acquired apparatus ID and the shaping data ID relating to the three-dimensional shaped object for which the shaping has been started in the server storage unit 102 in correlation with each other.

When the shaping of the three-dimensional shaped object has been completed, the three-dimensional shaping apparatus 300 executes step S325. In step S325, the three-dimensional shaping apparatus 300 transmits a shaping end signal for notifying that the shaping of the three-dimensional shaped object has been completed and the apparatus ID of the three-dimensional shaping apparatus 300 to the server 100. The apparatus ID transmitted to the server 100 in step S325 is the apparatus ID of the three-dimensional shaping apparatus 300 that has completed the shaping of the three-dimensional shaped object.

In step S330, the server 100 transmits a completion notification for notifying that the shaping of the three-dimensional shaped object has been completed and the reception code generated in step S320 to the user relating to the reception code. Here, the reception code transmitted by the server 100 is a reception code including, as information, the apparatus ID transmitted together with the shaping end signal in step S325. The user relating to the reception code is a user having a user ID stored in the server storage unit 102 in correlation with the shaping data ID included in the reception code as the information. For example, the server 100 transmits the reception code to the terminal apparatus 200 used by the user relating to the reception code to log in to the server 100. The server 100 may cause the server storage unit 102 to store the reception code such that the user relating to the reception code is capable of accessing the reception code in a state in which the user logs in to the server 100. As explained above, the shaping step is executed.

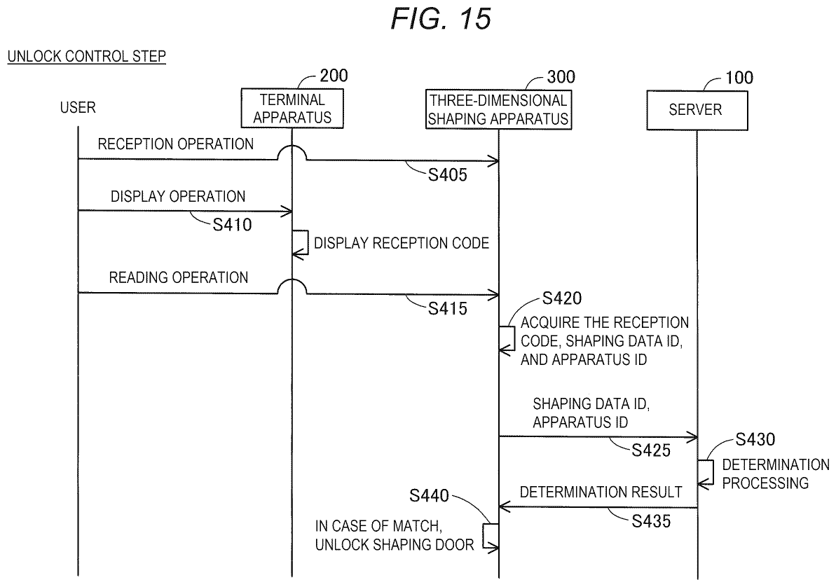

FIG. 15 is a diagram illustrating a sequence of the unlock control step.

In step S405, the user executes receiving operation on the three-dimensional shaping apparatus 300. The user taps the “receive shaped object” button BT6 on the shaping menu screen SC4 displayed on the shaping apparatus display unit 320. When the “receive shaped object” button BT6 is tapped, the three-dimensional shaping apparatus 300 causes the shaping apparatus display unit 320 to display a pop-up window on which a message “Please let me read a two-dimensional code.” is displayed.

In step S410, the user executes display operation on the terminal apparatus 200. The user causes the terminal apparatus display unit 204 to display the reception code of the three-dimensional shaped object for which the shaping has been completed.

In step S415, the user executes reading operation on the three-dimensional shaping apparatus 300. The user causes the reading unit 330 of the three-dimensional shaping apparatus 300 to read the reception code displayed on the terminal apparatus display unit 204. When the reading operation is executed, steps S420 to S440 are executed.

In step S420, the three-dimensional shaping apparatus 300 acquires the reception code read by the reading unit 330. The three-dimensional shaping apparatus 300 acquires, from the acquired reception code, the shaping data ID and the apparatus ID included in the reception code as the information. Step S420 is referred to as seventh step as well.

In step S425, the three-dimensional shaping apparatus 300 transmits the shaping data ID and the apparatus ID acquired in step S420 to the server 100. Step S425 is referred to as eighth step as well.

In step the S430, server 100 executes determination processing. The server 100 determines whether the apparatus ID transmitted in step S425 matches the apparatus ID of the three-dimensional shaping apparatus 300 at a transmission source. The server 100 determines whether the shaping data ID transmitted in step S425 matches a shaping data ID relating to the three-dimensional shaped object shaped in the shaping step. When both of the apparatus IDs and the shaping data IDs explained above match, the server 100 determines that a determination result is “match”. When at least one of the apparatus IDs and the shaping data IDs do not match, the server 100 determines that the determination result is “mismatch”. Step S430 is referred to as ninth step as well.

In step S435, the server 100 transmits the determination result determined in step S430 to the three-dimensional shaping apparatus 300.

In step S440, the three-dimensional shaping apparatus 300 receives the determination result transmitted in step S435. When the received determination result is “match”, the three-dimensional shaping apparatus 300 unlocks the shaping door 350 and causes the shaping apparatus display unit 320 to display a message “Thank you for your use.”. When the received determination result is “mismatch”, the three-dimensional shaping apparatus 300 does not unlock the shaping door 350 and causes the shaping apparatus display unit 320 to display a message “The shaped object is not a shaped object currently shaped by the three-dimensional shaping apparatus. Please perform re-authentication in another apparatus.”. Step S440 is referred to as tenth step as well. As explained above, the unlock control step is executed.

According to the first embodiment explained above, the three-dimensional shaping apparatus 300 shapes the three-dimensional shaped object in the housing 340 in the state in which the shaping door 350 is locked. After the shaping of the three-dimensional shaped object has been completed, the three-dimensional shaping apparatus 300 controls the unlocking of the shaping door 350 based on the shaping data ID and the apparatus ID included, as the information, in the reception code read by the reading unit 330. Specifically, the three-dimensional shaping apparatus 300 unlocks the shaping door 350 when the server 100 determines that the shaping data ID included in the reception code as the information matches the shaping data ID relating to the three-dimensional shaped object shaped in the shaping step and the apparatus ID included in the reception code as the information matches the apparatus ID of the three-dimensional shaping apparatus 300 at the transmission source. In the shaping step, the reception code is transmitted to the user having the user ID stored in the server storage unit 102 in correlation with the shaping data ID included in the reception code as the information. The user is the user who has transmitted the shaping data of the three-dimensional shaped object to the server 100 in the upload step. Therefore, it is possible to prevent a user other than the user who has transmitted the shaping data of the three-dimensional shaped object for which the shaping has been completed to the server 100 from taking out the three-dimensional shaped object for which the shaping is completed.

In the present embodiment, in the upload step, the server 100 generates the shaping data ID in which the shaping data ID and the user ID transmitted from the terminal apparatus 200 are associated. The server 100 generates the identification code including the generated shaping data ID as the information and transmits the generated identification code to the user relating to the identification code. Therefore, the user can acquire the identification code relating to the shaping data transmitted to the server 100.

In the present embodiment, in the shaping step, the server 100 generates the reception code including, as the information, the shaping data ID relating to the three-dimensional shaped object for which the shaping has been started and the apparatus ID of the three-dimensional shaping apparatus 300 that has started the shaping and transmits the generated reception code to the user relating to the reception code. Therefore, the user can acquire the reception code relating to the three-dimensional shaped object shaped based on the shaping data transmitted to the server 100.

### B. Second Embodiment

A second embodiment is different from the first embodiment in a shaping step and an unlock control step. The configurations of units of the three-dimensional shaping system 10 in the second embodiment are the same as the configurations in the first embodiment.

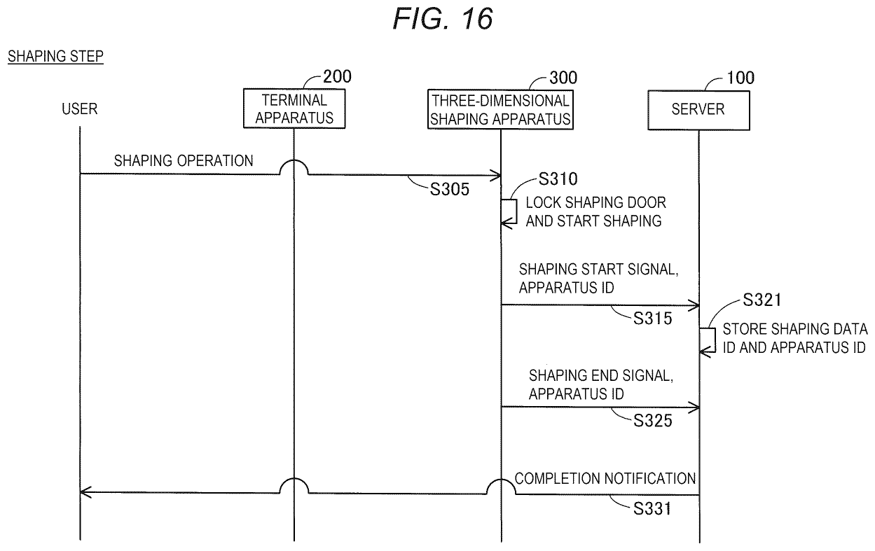

FIG. 16 is a diagram illustrating a sequence of the shaping step in the second embodiment. The same reference signs are added to the same portions as the portions of the sequence of the shaping step in the first embodiment illustrated in FIG. 14, and the explanation of the portions is omitted.

In step S321, the server 100 acquires the shaping start signal and the apparatus ID transmitted in step S315 and causes the server storage unit 102 to store the acquired apparatus ID and the shaping data ID relating to the three-dimensional shaped object for which the shaping has been started in correlation with each other. Here, the shaping data ID relating to the three-dimensional shaped object for which the shaping has been started is a shaping data ID relating to shaping data of the three-dimensional shaped object for which the shaping has been started. Specifically, the shaping data is the shaping data ID transmitted in step S225 of the shaping preparation step.

In step S331, the server 100 transmits a completion notification for notifying that the shaping of the three-dimensional shaped object has been completed to a user relating to the three-dimensional shaped object for which the shaping has been completed. Here, the user relating to the three-dimensional shaped object for which the shaping has been completed is a user having a user ID stored in the server storage unit 102 in correlation with the shaping data ID of the three-dimensional shaped object for which the shaping has been completed. For example, the server 100 transmits the completion notification to the terminal apparatus 200 used by the user to log in to the server 100.

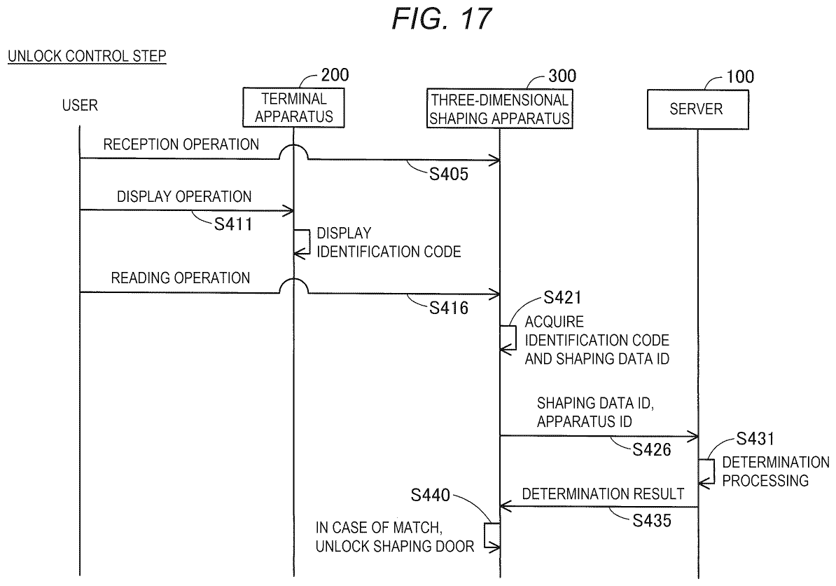

FIG. 17 is a diagram illustrating a sequence of the unlock control step according to the second embodiment. The same reference signs are added to the same portions as the portions in the sequence of the unlock control step in the first embodiment illustrated in FIG. 15, and explanation of the portions is omitted.

In step S411, the user executes display operation on the terminal apparatus 200. The user causes the terminal apparatus display unit 204 to display the identification code relating to the three-dimensional shaped object for which the shaping has been completed. Here, the identification code relating to the three-dimensional shaped object for which the shaping has been completed is an identification code including, as information, the shaping data ID of the three-dimensional shaped object for which the shaping has been completed. Specifically, the identification code is the identification code transmitted to the user in step S145 of the upload step.

step In S416, the user executes reading operation on the three-dimensional shaping apparatus 300. The user causes the reading unit 330 of the three-dimensional shaping apparatus 300 to read the identification code displayed on the terminal apparatus display unit 204.

In step S421, the three-dimensional shaping apparatus 300 acquires the identification code read by the reading unit 330. The three-dimensional shaping apparatus 300 acquires, from the acquired identification code, the shaping data ID included in the identification code as the information. Step S421 is referred to as seventh step as well.

In step S426, the three-dimensional shaping apparatus 300 transmits the shaping data ID acquired in step S421 and the own apparatus ID of the three-dimensional shaping apparatus 300 to the server 100. Step S426 is referred to as eighth step as well.

In step S431, the server 100 executes determination processing. The server 100 determines whether the shaping data ID and the apparatus ID transmitted in step S426 are stored in the server storage unit 102 in correlation with each other. When the shaping data ID and the apparatus ID are stored in the server storage unit 102 in correlation with each other, the server 100 determines that a determination result is “match”. When the shaping data ID and the apparatus ID are not stored in the server storage unit 102 in correlation with each other, the server 100 determines that the determination result is “mismatch”. Step S431 is referred to as ninth step as well.

According to the second embodiment explained above, after the shaping of the three-dimensional shaped object has been completed, the three-dimensional shaping apparatus 300 controls the unlocking of the shaping door 350 based on the shaping data ID and the apparatus ID included, as the information, in an identification code read by the reading unit 330. Specifically, the three-dimensional shaping apparatus 300 unlocks the shaping door 350 when the shaping data ID included, as the information, in the identification code acquired in the seventh step and the apparatus ID of the three-dimensional shaping apparatus 300 that has acquired the identification code in the seventh step are stored in the server storage unit 102 in correlation with each other. In the upload step, the identification code is transmitted to the user having the user ID stored in the server storage unit 102 in correlation with the shaping data ID included in the identification code as the information. The above-described user is the user who has transmitted the shaping data of the three-dimensional shaped object to the server 100 in the upload step. Therefore, it is possible to prevent a user other than the user who has transmitted the shaping data of the three-dimensional shaped object for which the shaping has been completed to the server 100 from taking out the three-dimensional shaped object for which the shaping is completed.

### C. Third Embodiment

In a third embodiment, an unlock control step

is different from the unlock control step in the first embodiment. The configurations of the units of the three-dimensional shaping system 10 in the third embodiment is the same as the configurations in the first embodiment.

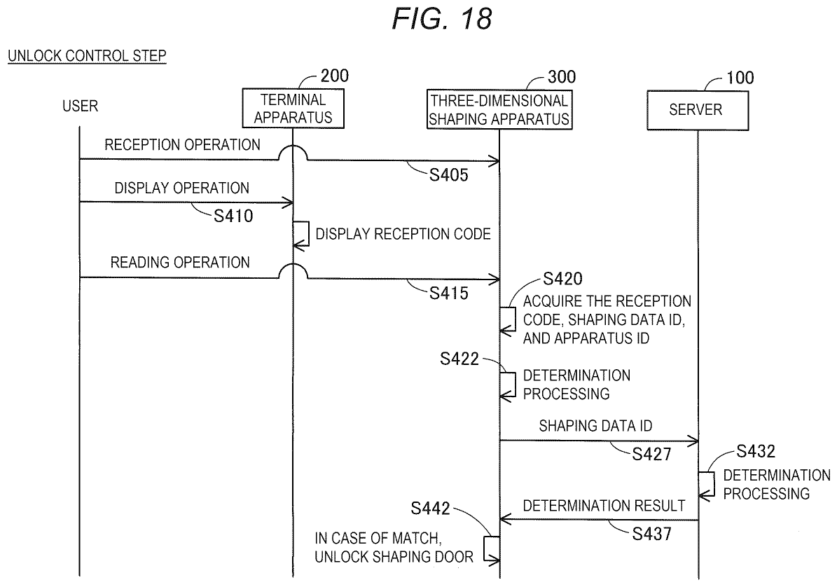

FIG. 18 is a diagram illustrating a sequence of the unlock control step in the third embodiment. The same reference signs are added to the same portions as the portions in the sequence of the unlock control step in the first embodiment illustrated in FIG. 15, and explanation of the portions is omitted.

In step S422, the three-dimensional shaping apparatus 300 determines whether the apparatus ID acquired in step S420 matches the apparatus ID of the three-dimensional shaping apparatus 300. When the apparatus ID acquired in step S420 and the apparatus ID of the three-dimensional shaping apparatus 300 match, the three-dimensional shaping apparatus 300 determines that a determination result of the apparatus IDs is “match”. When the apparatus ID acquired in step S420 and the apparatus ID of the three-dimensional shaping apparatus 300 do not match, the three-dimensional shaping apparatus 300 determines that the determination result of the apparatus IDs is “mismatch”.

In step S427, the three-dimensional shaping apparatus 300 transmits the shaping data ID acquired in step S420 to the server 100.

In step S432, the server 100 determines whether the shaping data ID transmitted in step S427 matches the shaping data ID relating to the three-dimensional shaped object shaped in the shaping step. When the shaping data ID transmitted in step S427 and the shaping data ID relating to the three-dimensional shaped object shaped in the shaping step match, the server 100 determines that a determination result of the shaping data IDs is “match”. When the shaping data IDs explained above do not match, the server 100 determines that the determination result of the shaping data IDs is “mismatch”.

In step S437, the server 100 transmits the determination result of the shaping data IDs determined in step S432 to the three-dimensional shaping apparatus 300.

In step S442, the three-dimensional shaping apparatus 300 receives the determination result of the shaping data IDs transmitted in step S437. When both of the determination result of the shaping data IDs and the determination result of the apparatus IDs are “match”, the three-dimensional shaping apparatus 300 unlocks the shaping door 350 and displays a message “Thank you for your use” on the shaping apparatus display unit 320. When at least one of the determination result of the shaping data IDs and the determination result of the apparatus IDs is “mismatch”, the three-dimensional shaping apparatus 300 does not unlock the shaping door 350 and causes the shaping apparatus display unit 320 to display a message “The shaped object is not a shaped object currently shaped by the three-dimensional shaping apparatus. Please perform re-authentication in another apparatus.”.

According to the third embodiment explained above, the three-dimensional shaping apparatus 300 determines whether the apparatus ID included in the acquired reception code as the information and the apparatus ID of the three-dimensional shaping apparatus 300 match. Therefore, it is possible to eliminate the need to transmit the apparatus ID included, as the information, in the reception code acquired by the three-dimensional shaping apparatus 300 to the server 100 for determination.

### D. Fourth Embodiment

In a fourth embodiment, an unlock control step is different from the unlock control step of the first embodiment. The configurations of the units of the three-dimensional shaping system 10 in the fourth embodiment are the same as the configurations in the first embodiment.

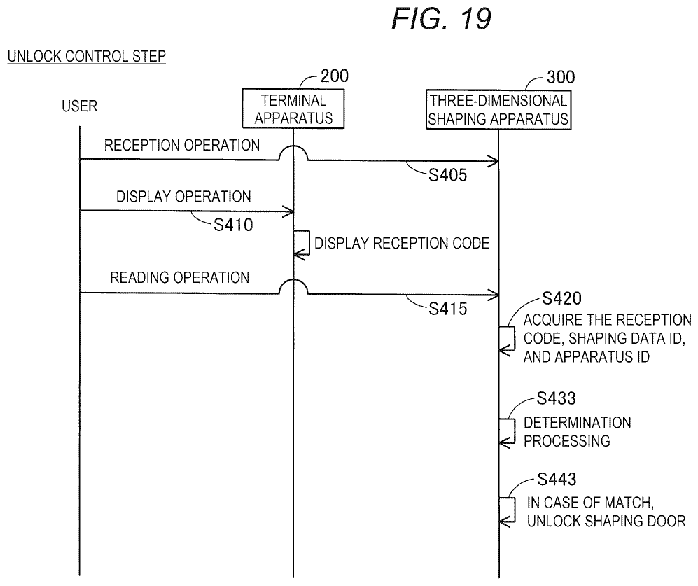

FIG. 19 is a diagram illustrating a sequence of the unlock control step according to the fourth embodiment. Note that the same reference signs are added to the same portions as the portions in the sequence of the unlock control step in the first embodiment illustrated in FIG. 15, and the explanation of the portions is omitted.

In step S433, the three-dimensional shaping apparatus 300 executes determination processing. The three-dimensional shaping apparatus 300 determines whether the shaping data ID acquired in step S420 matches the shaping data ID relating to the three-dimensional shaped object shaped in the shaping step. Specifically, the three-dimensional shaping apparatus 300 determines whether the shaping data ID acquired in step S420 matches the shaping data ID acquired in step S220 of the shaping preparation step. The three-dimensional shaping apparatus 300 determines whether the apparatus ID acquired in step S420 matches the apparatus ID of the three-dimensional shaping apparatus 300. When both of the shaping data IDs and the apparatus IDs match, the three-dimensional shaping apparatus 300 determines that a determination result is “match”. When at least one of the shaping data IDs and the apparatus IDs do not match, the three-dimensional shaping apparatus 300 determines that the determination result is “mismatch”.

In step S443, when the determination result in step S433 is “match”, the three-dimensional shaping apparatus 300 unlocks the shaping door 350 and causes the shaping apparatus display unit 320 to display a message “Thank you for your use.”. When the determination result of step S433 is “mismatch”, the three-dimensional shaping apparatus 300 does not unlock the shaping door 350 and causes the shaping apparatus display unit 320 to display a message “The shaped object is not a shaped object currently shaped by the three-dimensional shaping apparatus. Please perform re-authentication in another apparatus.”.

According to the fourth embodiment explained above, the three-dimensional shaping apparatus 300 determines whether the shaping data ID included in the acquired reception code as the information matches the shaping data ID relating to the three-dimensional shaped object shaped in the shaping step. The three-dimensional shaping apparatus 300 determines whether the apparatus ID included in the acquired reception code as the information matches the apparatus ID of the three-dimensional shaping apparatus 300. Therefore, it is possible to eliminate the need to transmit the shaping data ID and the apparatus ID included, as the information, in the reception code acquired by the three-dimensional shaping apparatus 300 to the server 100 for determination.

### E. Other Embodiments

(E-1) In the embodiments explained above, in step S125 of the upload step, the terminal apparatus 200 transmits the shaping data and the user ID to the server 100. In contrast, a computer, or a laptop computer, in which the shaping data is stored, different from the terminal apparatus 200 may transmit the shaping data and the user ID to the server 100. In this case, the user logs in to the server 100 using the computer or the laptop computer described above.
(E-2) In the embodiments explained above, in step S145 of the upload step, the server 100 transmits the identification code to the terminal apparatus 200 used by the user relating to the identification code for logging in to the server 100. In contrast, the server 100 may transmit the identification code to a computer or a laptop computer other than the terminal apparatus 200 used by the user relating to the identification code for logging into the server 100.
(E-3) In the embodiments explained, the user causes the reading unit 330 of the three-dimensional shaping apparatus 300 to read the identification code or the reception code displayed on the terminal apparatus display unit 204. In contrasts, the user may cause the reading unit 330 of the three-dimensional shaping apparatus 300 to read a printed identification code or reception code.

### F. Other Aspects

The present disclosure is not limited to the embodiments explained above and can be implemented in various aspects without departing from the gist of the present disclosure. For example, the present disclosure can be implemented by the following aspects. Technical features in the embodiments explained above corresponding to technical features in the aspects explained below can be replaced or combined as appropriate in order to solve a part or all of the problems of the present disclosure or in order to achieve a part or all of the effects of the present disclosure. Unless the technical features are explained as essential technical features in the present specification, the technical features can be deleted as appropriate.
(1) According to an aspect of the present disclosure, a method of manufacturing a three-dimensional shaped object is provided. The method of manufacturing a three-dimensional shaped object includes: a shaping step of, in a state in which a shaping door provided in a housing of a three-dimensional shaping apparatus is locked, controlling a discharge unit of the three-dimensional shaping apparatus based on shaping data and shaping the three-dimensional shaped object in the housing; and an unlock control step of, after the shaping step, controlling unlocking of the shaping door based on the shaping data, first identification information for identifying a user who transmitted the shaping data, and second identification information for identifying the three-dimensional shaping apparatus.

According to this aspect, the three-dimensional shaped object is shaped in the state in which the shaping door is locked and the unlocking of the shaping door is controlled based on the first identification information and the second identification information. Therefore, it is possible to prevent a user other than the user who transmitted the shaping data from taking out the three-dimensional shaped object in the housing.
(2) In the aspect explained above, the method of manufacturing the three-dimensional shaped object may further include an upload step executed before the shaping step, and the upload step may include: a first step in which a server that manages information concerning the three-dimensional shaped object acquires the shaping data and the first identification information; and a second step in which the server generates third identification information in which the shaping data and the first identification information acquired in the first step are associated with each other and stores the shaping data, the first identification information, and the third identification information in correlation with each other.
(3) In the aspect explained above, the upload step may include a third step in which the server generates fourth identification information, which is information for identifying the third identification information generated in the second step, and transmits the fourth identification information to the user relating to the fourth identification information.

According to this aspect, the user can acquire the fourth identification information relating to the transmitted shaping data.
(4) The aspect explained above, the method of manufacturing the three-dimensional shaped object may further include a shaping preparation step executed before the shaping step and after the upload step, and the shaping preparation step may include: a fourth step in which the three-dimensional shaping apparatus acquires the fourth identification information; and a fifth step in which the three-dimensional shaping apparatus transmits the third identification information relating to the fourth identification information acquired in the fourth step to the server.
(5) In the aspect explained above, the shaping preparation step may include a sixth step in which the server transmits the shaping data stored in correlation with the third identification information transmitted in the fifth step to the three-dimensional shaping apparatus that transmitted the third identification information in the fifth step.

According to this aspect, the three-dimensional shaping apparatus can acquire, from the server, the shaping data relating to the fourth identification information acquired in the fourth step.
(6) In the aspect explained above, the shaping step may include a step in which, when the shaping of the three-dimensional shaped object was started, the server generates fifth identification information in which the second identification information of the three-dimensional shaping apparatus that started the shaping and the third identification information relating to the three-dimensional shaped object for which the shaping was started are associated with each other.
(7) In the aspect explained above, the shaping step may include a step in which the server transmits the fifth identification information to the user relating to the fifth identification information when the shaping of the three-dimensional shaped object was completed.

According to this aspect, the user can acquire the fifth identification information relating to the three-dimensional shaped object shaped based on the transmitted shaping data.
(8) In the aspect explained above, the unlock control step may include: a seventh step in which the three-dimensional shaping apparatus acquires the fifth identification information; and an eighth step in which the three-dimensional shaping apparatus transmits the second identification information and the third identification information relating to the fifth identification information acquired in the seventh step to the server.
(9) In the aspect explained above, the unlock control step may include a ninth step in which the server determines whether the second identification information transmitted in the eighth step matches the second identification information of the three-dimensional shaping apparatus at a transmission source and whether the third identification information transmitted in the eighth step matches the third identification information relating to the three-dimensional shaped object shaped in the shaping step.
(10) In the aspect explained above, the unlock control step may include a tenth step of unlocking the shaping door when it is determined in the ninth step that the second identification information and the third identification information match.

According to this aspect, the shaping door is unlocked when the second identification information relating to the fifth identification information acquired in the seventh step matches the second identification information at the transmission source and the third identification information relating to the fifth identification information acquired in the seventh step matches the third identification information relating to the three-dimensional shaped object shaped in the shaping step. That is, the shaping door is unlocked when the three-dimensional shaping apparatus acquires the fifth identification information from the user having the fifth identification information satisfying the condition explained above. The user having the fifth identification information satisfying the condition explained above is a user who transmitted the shaping data relating to the fifth identification information satisfying the condition explained above. Therefore, it is possible to prevent a user other than the user who transmitted the shaping data from taking out the three-dimensional shaped object in the housing.
(11) In the aspect explained above, the shaping step may include a step in which, when the shaping of the three-dimensional shaped object was started, the server stores the second identification information of the three-dimensional shaping apparatus that started the shaping and the third identification information relating to the three-dimensional shaped object for which the shaping was started in correlation with each other.
(12) In the aspect explained above, the shaping step may include a step in which, when the shaping of the three-dimensional shaped object was completed, the server notifies the user relating to the three-dimensional shaped object for which the shaping was completed that the shaping of the three-dimensional shaped object was completed.

According to this aspect, the user can recognize that the shaping of the three-dimensional shaped object based on the transmitted shaping data was completed.
(13) In the aspect explained above, the unlock control step may include: a seventh step in which the three-dimensional shaping apparatus the acquires fourth identification information; and an eighth step in which the three-dimensional shaping apparatus transmits the second identification information of the three-dimensional shaping apparatus and the third identification information relating to the fourth identification information acquired in the seventh step to the server.
(14) In the aspect explained above, the unlock control step may include a ninth step in which the server determines whether the second identification information and the third identification information transmitted in the eighth step are stored in correlation with each other.
(15) In the aspect explained above, the unlock control step may include a tenth step of unlocking the shaping door when it is determined in the ninth step that the second identification information and the third identification information are stored in correlation with each other.

According to this aspect, the shaping door is unlocked when the second identification information of the three-dimensional shaping apparatus that acquired the fourth identification information in the seventh step and the third identification information relating to the fourth identification information acquired in the seventh step are stored in correlation with each other. That is, the shaping door is unlocked when the three-dimensional shaping apparatus acquires the fourth identification information relating to the third identification information stored in correlation with the second identification information of the three-dimensional shaping apparatus. The user having the fourth identification information explained above is a user who transmitted the shaping data relating to the fourth identification information explained above. Therefore, it is possible to prevent a user other than the user who transmitted the shaping data from taking out the three-dimensional shaped object in the housing.

What is claimed is:

1. A method of manufacturing a three-dimensional shaped object, comprising:
a shaping step of controlling a discharge unit of the three-dimensional shaping apparatus based on shaping data in a state in which a shaping door provided in a housing of the three-dimensional shaping apparatus is locked and shaping the three-dimensional shaped object in the housing; and
an unlock control step of, after the shaping step, controlling unlocking of the shaping door based on the shaping data, first identification information for identifying a user who transmitted the shaping data, and second identification information for identifying the three-dimensional shaping apparatus.

2. The method of manufacturing a three-dimensional shaped object according to claim 1, further comprising an upload step executed before the shaping step, wherein
the upload step includes:
a first step in which a server that manages information concerning the three-dimensional shaped object acquires the shaping data and the first identification information; and
a second step in which the server generates third identification information in which the shaping data and the first identification information acquired in the first step are associated with each other and stores the shaping data, the first identification information, and the third identification information in correlation with each other.

3. The method of manufacturing a three-dimensional shaped object according to claim 2, wherein the uploading step includes a third step in which the server generates fourth identification information, which is information for identifying the third identification information generated in the second step, and transmits the fourth identification information to the user relating to the fourth identification information.

4. The method of manufacturing a three-dimensional shaped object according to claim 3, further comprising a shaping preparation step executed before the shaping step and after the upload step, wherein
the shaping preparation step includes:
a fourth step in which the three-dimensional shaping apparatus acquires the fourth identification information; and
a fifth step in which the three-dimensional shaping apparatus transmits the third identification information relating to the fourth identification information acquired in the fourth step to the server.

5. The method of manufacturing a three-dimensional shaped object according to claim 4, wherein the shaping preparation step includes a sixth step in which the server transmits the shaping data stored in correlation with the third identification information transmitted in the fifth step to the three-dimensional shaping apparatus that transmitted the third identification information in the fifth step.

6. The method of manufacturing a three-dimensional shaped object according to claim 5, wherein the shaping step includes a step in which, when the shaping of the three-dimensional shaped object was started, the server generates fifth identification information in which the second identification information of the three-dimensional shaping apparatus that started the shaping and the third identification information relating to the three-dimensional shaped object for which the shaping was started are associated with each other.

7. The method of manufacturing a three-dimensional shaped object according to claim 6, wherein the shaping step includes a step in which the server transmits the fifth identification information to the user relating to the fifth identification information when the shaping of the three-dimensional shaped object was completed.

8. The method of manufacturing a three-dimensional shaped object according to claim 7, wherein the unlock control step includes:
a seventh step in which the three-dimensional shaping apparatus acquires the fifth identification information; and
an eighth step in which the three-dimensional shaping apparatus transmits the second identification information and the third identification information relating to the fifth identification information acquired in the seventh step to the server.

9. The method of manufacturing a three-dimensional shaped object according to claim 8, wherein the unlock control step includes a ninth step in which the server determines whether the second identification information transmitted in the eighth step matches the second identification information of the three-dimensional shaping apparatus at a transmission source and whether the third identification information transmitted in the eighth step matches the third identification information relating to the three-dimensional shaped object shaped in the shaping step.

10. The method of manufacturing a three-dimensional shaped object according to claim 9, wherein the unlock control step includes a tenth step of unlocking the shaping door when it is determined in the ninth step that the second identification information and the third identification information match.

11. The method of manufacturing a three-dimensional shaped object according to claim 5, wherein the shaping step includes a step in which, when the shaping of the three-dimensional shaped object was started, the server stores the second identification information of the three-dimensional shaping apparatus that started the shaping and the third identification information relating to the three-dimensional shaped object for which the shaping was started in correlation with each other.

12. The method of manufacturing a three-dimensional shaped object according to claim 11, wherein the shaping step includes a step in which, when the shaping of the three-dimensional shaped object was completed, the server notifies the user relating to the three-dimensional shaped object for which the shaping was completed that the shaping of the three-dimensional shaped object was completed.

13. The method of manufacturing a three-dimensional shaped object according to claim 12, wherein the unlock control step includes:
a seventh step in which the three-dimensional shaping apparatus acquires the fourth identification information; and
an eighth step in which the three-dimensional shaping apparatus transmits the second identification information of the three-dimensional shaping apparatus and the third identification information relating to the fourth identification information acquired in the seventh step to the server.

14. The method of manufacturing a three-dimensional shaped object according to claim 13, wherein the unlock control step includes a ninth step in which the server determines whether the second identification information and the third identification information transmitted in the eighth step are stored in correlation with each other.

15. The method of manufacturing a three-dimensional shaped object according to claim 14, wherein the unlock control step includes a tenth step of unlocking the shaping door when it is determined in the ninth step that the second identification information and the third identification information are stored in correlation with each other.
